(19) United States
(12) Patent Application Publication
(10) Pub. No.: US 2025/0054415 A1
(43) Pub. Date: Feb. 13, 2025

(54) INSERTING INSTRUMENTS INTO THE EYE IN A MODEL FOR SURGICAL SIMULATION

(71) Applicant: Bioniko Consulting, LLC, Sunny Isles, FL (US)

(72) Inventor: Andres BERNAL, Sunny Isles, FL (US)

(73) Assignee: Bioniko Consulting, LLC, Sunny Isles, FL (US)

(21) Appl. No.: 18/231,974

(22) Filed: Aug. 9, 2023

(51) Int. Cl. G09B 23/30

(52) U.S. Cl. CPC G09B 23/303

(57) ABSTRACT

A surgical model has a layer through which a surgical instrument is passed, such as a cornea or sclera. When the model is manufactured, a tunnel is pre-formed with a cross-sectional profile that does not include sharp bends which can lead to stress-risers, the latter tending to cause cracking of failure of the integrity of the layer. The pre-formed tunnel profile includes only radiused directional changes which tend not to lead to stress risers. The pre-formed tunnel can include tapered sidewalls which form a more narrow and flexible contact with a tool passed through the tunnel, reducing friction, improving mobility of the instrument, and enabling greater control of the pressure imparted upon the tool by the pre-formed tunnel.

### FIELD OF THE DISCLOSURE

This disclosure relates to simulating eye surgery, and more particularly to artificially reproducing the practice and result of inserting a surgical tool into the eye in an eye model.

### BACKGROUND OF THE DISCLOSURE

Many surgical techniques require dexterous movement and control by the surgeon. This dexterity cannot be adequately developed by reading textbooks or watching instructional videos. Animal models or cadavers have been the default method for hands-on surgical training. Today, simple models of the eye and head are available for study or practice.

An eye model can include a cornea into which a surgical instrument is inserted, in order to simulate insertion of surgical tools in an actual surgical procedure, such as phacoemulsification.

### SUMMARY OF THE DISCLOSURE

In an embodiment of the disclosure, a device for simulating surgery upon a natural eyeball comprises at least a portion of an eyeball corresponding to the natural eyeball simulated, including an eyeball layer through which a surgical instrument is to be passed during the simulated surgery; and a tunnel formed through the eyeball layer, the tunnel defining a cross-sectional profile substantially along the plane of the surface through which the surgical instrument is to be passed, the tunnel forming a taper along a depth defined as extending from a surface facing an exterior of the eye to a surface facing an interior of the eye.

In variations thereof, the cross section defining direction changes of only curved shapes; whereby the tunnel does not form stress risers of sharp directional changes along the cross-section which can split when the surgical instrument is passed through the tool and moved during the surgical simulation; the curved shapes define one or more of a circular, oval, elliptical, parabolic, and/or a complex curve, the tunnel not defining substantially non-curved directional changes along the cross-section; and/or the complex curve shape defines a curvy direction change formed by multiple radii; the tunnel is formed in the cornea and the surgery simulated is phacoemulsification; and/or the eyeball layer is formed of a resilient material.

In further variations thereof, at least a portion of the cross-section of the tunnel is sized smaller than a cross-section of the tool coplanar with the cross-section of the tunnel where the tool passes through the tunnel, whereby the tool forms an interference fit with tunnel; the tunnel diameter narrows at a point along a depth of the tunnel between an outer surface of the eye and an inner surface of the eye; the taper narrows toward the interior of the eye; the taper narrows toward the exterior of the eye; and/or the taper narrows at a point along the depth of the tunnel between the interior and exterior of the eye.

In other variations thereof, the tunnel forms a taper along a depth defined as extending from a surface facing an exterior of the eye to a surface facing an interior of the eye; and wherein at least a portion of the cross-section of the tunnel through the taper is sized smaller than a cross-section of the tool coplanar with the cross-section of the tunnel where the tool passes through the taper, whereby the tool forms an interference fit with taper.

In another variation thereof, the layer through which the tunnel is formed is of a resilient material, the tunnel forms a taper along a depth defined as extending from a surface facing an exterior of the eye to a surface facing an interior of the eye, and the taper narrows toward the interior of the eye; and the taper is folded inwards towards the interior of the eye and forms a seal with a surgical instrument, when a surgical instrument is inserted through the tunnel.

In variation of the foregoing, the surgical instrument includes a deformable tube for conducting fluids between the interior and the exterior of the eye; and/or the folded taper forms an interference fit with the deformable tube, the taper compresses the deformable tube to block fluid flow through the tube, whereby a first fluid pressure level can be introduced into the deformable tube from an exterior of the eye at which the compression of the taper is overcome and fluid can flow into the eye, a second fluid pressure level can develop within the eye at which the compression of the taper is overcome and fluid can flow out of the eye, and the second fluid pressure level is greater than the first fluid pressure, the taper thereby forming a type of one-valve; and/or the folded taper forms an interference fit with the deformable tube, preventing fluid flow past the interference fit at a predetermined fluid pressure.

In another embodiment of the disclosure, a synthetic eye model for simulating phacoemulsification procedures, comprising a flexible cornea having a pre-made tunnel with a continuous and smooth cross-sectional profile, substantially free from sharp corners or stress points.

In variations thereof, the pre-made tunnel has a cross-sectional profile characterized by one or more curved or rounded geometries; the pre-made tunnel has a cross-sectional profile selected from the group consisting of circular, elliptical, parabolic, and spline-based shapes; the pre-made tunnel has a cross-sectional profile that has a larger diameter nearest an exterior of the eye and a smaller diameter nearest an interior of the eye, and which forms a taper between the larger diameter to the smaller diameter, whereby a tool tip is guided along the taper to engage the smaller diameter in an interference fit, to thereby reduce the potential for a leak of fluid from inside the eye to an exterior of the eye when a tool is inserted into the tunnel.

### BRIEF DESCRIPTION OF THE DRAWINGS

A more complete understanding of the disclosure, and the attendant advantages and features thereof, will be more readily understood by reference to the following detailed description when considered in conjunction with the accompanying drawings, in which:

FIG. 1 depicts a bisecting cross-section through an eye model with a pre-formed tunnel through an eye model layer, in FIG. 1 a cornea of the eye, in accordance with the disclosure, the tunnel forming a taper;

FIG. 2 depicts the eye model of FIG. 1, with a surgical instrument passed through the tunnel;

FIG. 3 depicts a bisecting cross-section through an eye model with a tunnel formed through the cornea in accordance with the disclosure, the tunnel forming a taper and an elongated shape;

FIG. 4 depicts a detail of an elongated tunnel of the disclosure, the tunnel not forming a taper;

FIG. 5 depicts a detail of an oval shaped tunnel in accordance with the disclosure;

FIG. 6 depicts a detail of a round shaped tunnel not having a taper, in accordance with the disclosure;

FIG. 7 depicts a detail of a round shaped tunnel of the disclosure, the tunnel forming a taper that expands towards the interior of the eye;

FIG. 8 depicts a detail of a tunnel of the disclosure including a taper formed at a location along the depth of the tunnel which is not at the outer or inner surface of the layer;

FIG. 9 depicts a cross-section of an eye model having a layer with a pre-formed tunnel of the disclosure, the tunnel forming a taper narrowing at an inner surface of the layer;

FIG. 10 depicts a cross-section of an eye model having a layer with a pre-formed tunnel, the tunnel formed at a non-orthogonal angle with respect to a surface of the layer;

FIG. 11 depicts a cross-section of an eye model having a layer with a pre-formed tunnel, the tunnel forming a taper having a narrowest portion at an interior side of the layer, the taper folded over by insertion of a resilient sleeve of a surgical instrument, the taper compressing the sleeve to form a liquid tight seal at an interface between the taper and the sleeve, FIG. 11 further depicting that the taper can be sized to also constrict or form a water tight seal between the sleeve and an inserted instrument, if desired;

FIG. 12 depicts a tunnel of the disclosure, viewed orthogonal to the surface of the layer through which the tunnel is formed, showing end portions of the tunnel formed as wavy lines comprising a series of arcs, without sharp bends, the tunnel further having a taper in this embodiment;

FIG. 13 depicts a cross-section of an eye model having a layer with a pre-formed tunnel of the disclosure, the tunnel forming a taper that has a curved radii beginning along a surface of the eye and extending towards a narrower portion closer to the interior of the eye; and

FIG. 14 depicts the tunnel of FIG. 13, provided with a narrow portion having vertical walls.

### DETAILED DESCRIPTION OF THE DISCLOSURE

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Headings are provided for the convenience of the reader, and are not intended to be limiting in any way.

The invention is carried out using an eye model in which an instrument is passed from an exterior of the eyeball into an interior of the eyeball, or is passed through any other layer of the eye in an eye model. In particular, the invention can be used with a resilient eye surface such as is described in the inventor's U.S. Pat. Nos. 10,360,815; 10,636,325; and 11,127,314, or any other eye model through which an instrument is passed through a layer of the eye.

During a surgical procedure such as phacoemulsification, an opening is formed in the cornea with a knife thereby forming a slit, after which an instrument can be inserted. In the natural eye, the corners formed at each end of the slit naturally become wet and an at least somewhat effective seal is formed, which can contain fluids of the eye and fluids introduced into the eye during surgery. During surgical simulation, a slit can be formed in a similar manner, provided that the eye layer, such as the representation of the cornea, is resilient. In a like manner, fluids can be added to the slit after insertion of the instrument to form a seal.

However, the inventor has found that, in such a simulated eye, the ends/corners of the slit form stress risers, or weak points, which can lead to cracking, splitting, and/or otherwise forming an extension of the slit upon insertion and manipulation of a tool, which further reduces the seal, and which can lead to turbulence and other problems during the simulation. Silicone oil can be added to reduce friction due to insertion of an instrument, such as a phaco tip or canula, to lubricate and promote a seal, but this can be insufficient to overcome the problem of splitting. As the slit elongates due to splitting, the size of the opening becomes larger and the seal is reduced or lost, resulting in a simulation which is less representational of an actual surgery.

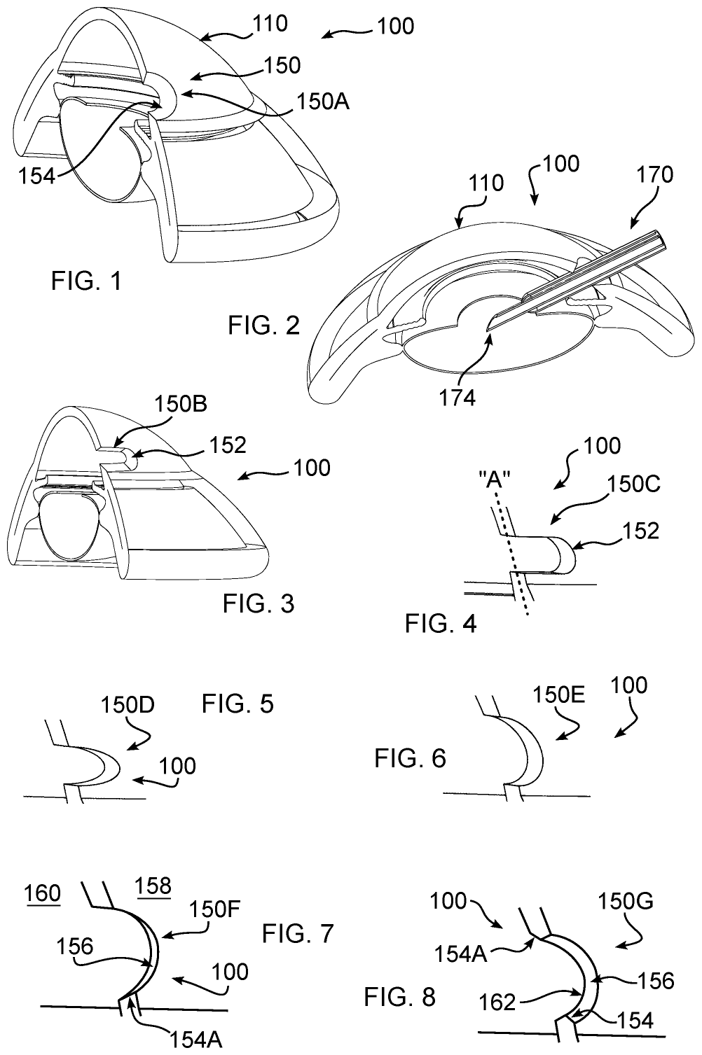

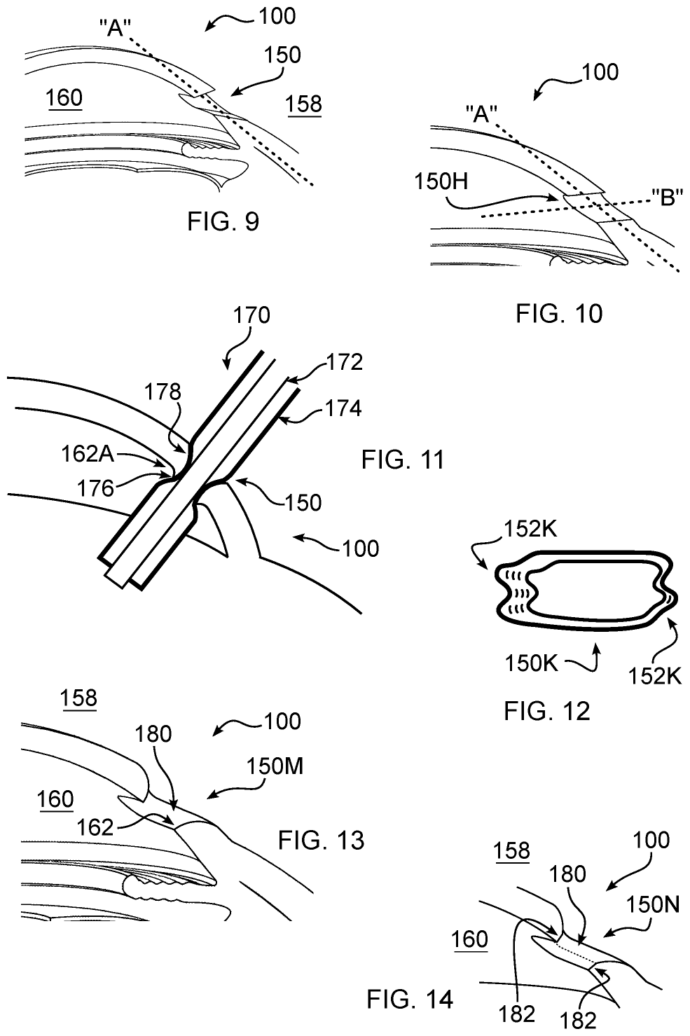

In accordance with the disclosure, and with reference to FIG. 1, an eye model 100 includes a cornea 110 through which a tool tunnel 150 is pre-formed. In FIG. 1, a cross-sectional profile of the tunnel “A” (FIGS. 4 and 9) is defined substantially at the plane of the layer through which the tunnel passes, where this tunnel 150 cross-sectional profile does not form ends with sharp bends, such as corners, inflection points, or acute angles, any of which the inventor has found can lead to stress risers which can in turn lead to tears and cracks in the simulated eye layer through which tunnel 150 passes. More particularly, the round shape of tunnel 150A does not form ends, but rather a continuous boundary having a smooth radius. As can be seen in FIGS. 3 and 4, other openings herein, including tunnels 150B and 150C are elongate, yet likewise form a continuous boundary without sharp bends. More particularly, tunnels 150B and 150C also form a smooth radius at each tunnel end 152. In this manner, whether round or shaped, tunnel 150 does not form an opening with non-radiused ends. If opening 150 forms a circle, there are no ends, but only a continuous circular radius. Alternatively, if opening 150 forms an elongate or other shape with ends, the ends form any of a circular or oval shaped radius, or a combination of radii, such as a wavy line. Other shapes besides circular which likewise do not contain sharp directional changes include elliptical, parabolic, and or complex curve shapes such as a spline-based curve.

In all the figures, the eye model is shown bisected to best depict the location and characteristics of the tunnel. As such, only one end 152 of a tunnel 150 is depicted. It may be assumed that in the examples shown the tunnel is symmetrical, although the tunnel need not be symmetrical in order to carry out the disclosure (e.g. FIG. 12).

FIGS. 4-7 depict a detail of the area of tunnel 150 of model 100. As can be seen, other shapes, including the oval shape of tunnel 150D of FIG. 5 can be pre-formed which likewise have radiused corners which do not form a sharp bend. The particular shape is selected to best conform to the anticipated shape of a surgical tool to be passed into tunnel 150. In this manner, the tool imparts less stress on the tunnel. The overall size and dimension of the tunnel is selected to provide a sufficient interference fit with the tool to form a liquid tight seal about most, or all of the tool periphery. The tension of the interference fit is selected to correspond to the pressure created inside the eye model during simulation of the surgical procedure. The conforming shape further reduces overall friction during insertion of the tool tip and tip body (FIG. 2).

With reference to FIGS. 1-3 and 7-9, it may be seen that in addition to not forming sharp bends, tunnel 150 can be tapered, wherein the diameter of the tunnel 150 is reduced over its depth into and through the simulated layer. As can be seen in FIGS. 1-3 and 9, the diameter decreases as tunnel 150 extends interiorly towards the center of the eye model 100. In this manner, the sleeve 172 or tip 174 of tool 170 is guided along a slope 154 (FIG. 1) towards alignment with the center of tunnel 150, further reducing stress on the periphery of tunnel 150.

The invention can also be carried out with a slope 154A which expands towards the interior of the eye, as shown in FIG. 7. The sidewall 156 of the preformed tunnel 150F forms a tunnel that is most narrow at the surface of the eye 158 and expand towards the inside of the eye 160.

Further, can be seen in FIG. 8, the sidewall 156 of the preformed tunnel 150G can form a tunnel that narrows from the outside of the eye 158 towards the interior 160, and then expands again, thereby forming a narrow portion 162 along the sidewall 156 between the outer and interior portions of the eye 158, 160. The narrow portion 162 is thus formed with adjacent inner and outer support.

In addition to guiding an instrument to a center of tunnel 150, a sloped sidewall 156 presents less friction during insertion of an instrument, as there is less surface area engaged by the instrument.

If tunnel 150 is too large, the seal will be incomplete or weak, promoting leaks. Alternatively, if tunnel 150 is too small, there may be compression of an inserted tool, for example a silicone sleeve of a phaco tip, impeding inflow of fluid. The tapered tunnels 150 of the disclosure can form a better seal as each can present a smaller entry aperture with lower insertion resistance. Having less material, the engaging surface area is more flexible and can therefore more easily contour to the instrument. This flexibility also enables the dimensions of tunnel 150 to be less precise while still enabling a liquid tight seal where engaging a tool periphery.

With reference to FIG. 11, which is a detail of the tunnel 150 area of FIG. 9, in an embodiment, a tapered tunnel 150 can act as a valve, where pressure within an inserted portion of a flexible tool 170 can cause a narrow portion 162A to deform inwards, or fold over inwards towards the interior of the eye, constricting outflow. In particular, narrowed portion 162A defines an annular region of thinner material which is more easily displaced relative to surrounding material. As such, narrow portion 162A can be sized and dimensioned to form a one way valve in which a leading edge 176 of narrow portion 162A is formed by engagement with tool 170 to face towards the interior of the eye 160, and a radiused portion 178 faces in an inflow direction at an exterior of the eye 180. Leading edge 176 is pressed further against the inserted portion of a flexible tool 170 when pressure within the eye is increased, leading to a tighter seal between leading edge 176 and tool 170. However, at the exterior of the eye 158, radiused portion 178 forms a slope which can be displaced away from tool 170 when fluid is introduced into sleeve 172 under pressure.

In FIG. 10, a tunnel 150K is formed in a layer of the eye model, the tunnel passing through the layer at a substantially non-orthogonal angle relative to the surface of the eye. While the surface of the layer, in this example a cornea, is not planar, it may be seen that a plane of the surface of the cornea at the location of the tunnel may be approximated by line “A”. It may be seen that line “B” is non-orthogonal to line “A”. In this manner, an angle at which a surgical instrument is typically inserted and manipulated with respect to line “A” can be anticipated, and tunnel 150K can be formed at the same or a similar angle, thereby reducing stress on tunnel 150K during the procedure, and facilitates insertion and orientation of the instrument for the user. An angular disposition as such can be formed with other embodiments of tunnel 150 herein, including for example tapered embodiments, such as can be seen in FIG. 9.

In the example of FIG. 11, an irrigation sleeve 172 is compressed between narrow portion 162A and a phaco tip 174 of tool 170, preventing leakage between irrigation sleeve 172 and phaco tip 174. However, the material and dimensions of narrow portion 162A can be selected to allow fluid to be introduced into sleeve 172 from outside of the eye at a pressure sufficient to push back narrow portion 162A without introducing excess pressure into the eye. Pressure is maintained within the eye at least by a seal formed between narrow portion 162A and irrigation sleeve 172, and can further be formed between other portions of tapered sidewall 156 and sleeve 174. Additional sealing strength can be realized if a tubular instrument is inserted within sleeve 172, where sidewalls 156 and/or narrow portion 162A bears against sleeve 172, and sleeve 172 bears against the inserted tubular instrument. In the example the sleeve is silicone, and the inserted tubular instrument is a phaco tip 172, however other surgical instruments can cooperatively form a seal with narrow portion 162A or any other portion of tunnel 150 in a like manner as described herein.

As such, the folded taper of the narrow portion 162A forms an interference fit with the deformable sleeve 172, the narrow portion compressing sleeve 172 to block fluid flow through sleeve 172. However, fluid can be introduced from outside of the eye to overcome the compression and permit flow into the eye. Likewise, pressure inside the eye can be sufficient to overcome the compression of the narrow portion 162A, but it is of a greater pressure than is needed to overcome the compression flowing inwards, as additional pressure tends to press the folded narrow portion 162A more tightly against sleeve 172. In this manner, narrowed portion 162A forms a type of one-way valve in combination with sleeve 172.

Alternatively or additionally, narrow portion 162A can be sized and dimensioned to engage sleeve 172 with a force that does not collapse sleeve 172 against the tubular instrument thereby enabling free flow of fluids into or out of the eye.

Accordingly, in various embodiments of the disclosure, a tapered tunnel enables greater control of the pressure imparted upon an inserted tool, as the thickness of the narrow portion 162A, regardless of its location within tunnel 150, and the diameter of the opening formed by narrow portion 162A, can be selected to impart a predetermined force upon the tool, thus forming a valve of desired pressure controlling characteristics.

Where tunnel 150 is not tapered, sealing can occur peripherally about an interface between part or all of sidewall 156 of tunnel 150 and an inserted tool periphery. Various tunnel 150 shapes have been shown and described herein, however other shapes which conform to instruments to be used can be provided. Further, a tunnel 150 can be sized and dimensioned to admit passage of multiple instruments while avoiding cracking and splitting as described herein. As examples, the elongate tunnels 150B and 150C can be used with two or more side by side instruments, or a single instrument with adjacent attached tubes, although other shapes, for example a clover shape, can also form a seal between more than two instruments in accordance with the disclosure.

While the figures depict tunnel 150 formed within the cornea, tunnel 150 can be formed in other parts of the simulated eye, such as the limbus or sclera, or within an interior structure, such as the lens capsule, otherwise as described herein.

FIG. 12 depicts a tapering tunnel 150K having ends 152K with multiple curved geometries, illustrating that, in accordance with the disclosure, ends or other shape changes can be formed to avoid sharp angles by a single or multiple arcs, rounded lines, or other curved geometries, thereby avoiding stress rising sharp angles.

The eye can conveniently be considered as being composed of collagen type tissue, and elastin type tissue, where a different material can be used to produce each type of tissue in the eye model. However, regardless of how various tissues in the eye are classified with respect to collagen or elastin, materials printed are ultimately selected to have a hardness and resiliency which mimics structures of the natural organ. More particularly, materials are selected whereby the resultant tissue simulation behaves in a manner similar to a live or donor eye, with respect to resistance to pressure, piercing and cutting, burning/ablation, manipulation, and other applications of force, as well as physical appearance. Such materials can include polymers, elastomeric materials, rubber, latex, acrylic, acrylic elastomers, or other material which meet the foregoing criteria, or a mixture of such materials. The foregoing criteria can also be met using materials not suggested, and materials not yet known.

As such, the inventor has observed that known materials which exhibit the natural properties of the eye also exhibit the tendency to crack or split when a force is applied to sharp bends, such as the force exerted to insert a surgical instrument while forming a seal, or the force exerted when an inserted tool is manipulated. Accordingly, the disclosure provides for rounded opening shapes which do not form sharp bends. As a non-limiting example, using the example materials described herein and in the incorporated references, bends or corners having a radius of less than 0.1 mm (a 0.2 mm diameter) present a significant increase in the risk of splitting, cracking, or tearing (failure), although the risk is somewhat dependent on the particular materials or mix of materials used, and how the materials were prepared and treated during formulation of the eye model. An increased radius, such as 1.5 mm, would present a significantly lower risk of failure, but as such, may not reasonably represent a typical actual profile of a surgical incision. Accordingly, these would typically represent bounds in radii in accordance with the disclosure, although more practical bounds would be more limited, and within these bounds, such as 0.15 mm and 1.3 mm, or more typically, between 0.2 mm and 1 mm.

It should be understood, however, that certain materials may exhibit a greater or lesser tendency to fail upon a sharp bend, and therefore these bounds may be different. However, in accordance with the disclosure, a smooth radius size is selected for a given material which limits this type of failure to acceptable levels, for example in less than 1% of surgeries simulated, or 0.5%, or 0.25%, dependent upon the cost of carrying out the simulation, and other factors.

In accordance with an additional aspect of the disclosure, and with reference to FIG. 13, a tunnel 150M of the disclosure presents a taper forming a curved entry profile 180 beginning along a surface of the eye. In a variation, the curved entry profile is tangential to a surface of the eye. In this manner, tool tip 174 is more easily inserted, and tool tip 174 is guided into tunnel 150M along curved entry profile 180, relieving stress which can be presented by tool tip 174 engaging a sharp edged periphery of a tunnel 150 prior to being inserted into the tunnel. The radius of curved entry profile 180 is selected to be sufficiently gradual to readily guide a tool tip, without resulting in an excessively narrow profile at a narrow portion 162 of the tunnel, and without producing excessive tapering resulting in a tunnel of insufficient diameter at a narrowest portion. Alternatively, as shown in FIG. 14, tunnel 150N can be provided with a narrow portion 182 nearest an interior of the eye 160, which has vertical walls or walls having a less gradual radius than curved entry profile 180, to thereby strengthen narrow portion 182 and ensure a sufficient diameter to form a seal with tool 170.

The disclosure thus provides an alternative to forming an incision with a sharp, flat keratome blade, for example, which creates a slit-type wound with stress points at the corners of the incision. In a synthetic eye, this wound structure also results in difficulty inserting the silicone sleeve through the flat wound, usually requiring enlargement or assistance with a second instrument. Manipulation of the needle through the wound causes additional tearing along the stress points at the corners, thus enlarging the wound results in additional egress of fluid and turbulence in the anterior chamber of the eye. This results in less than optimum fluidics, and thus the simulation fidelity is compromised, and results in frustration for the user.

The disclosure provides a synthetic eye model for simulating one or more surgical procedures. For example, during phacoemulsification procedures, a coaxial needle within a silicone sleeve is inserted through a corneal incision in a flexible cornea, while maintaining a fluid-tight seal with the surrounding simulated tissue. This disclosure provides an eye model with a flexible cornea featuring a tapered pre-made tunnel that can be created using various methods, including as non-limiting examples a side-action pin in a mold, 3D printing, or a die punch. The pre-made tunnel will form an opening without sharp bends, such as a circle, ellipse, or slot with curved ends, avoiding corners that can introduce stress risers. This will not only facilitate simulation by not requiring the use of dangerous and expensive sharps to create the incision, but will conform perfectly to the phacoemulsification irrigation sleeve or other tool, creating a better seal. The entry of the sleeve in the wound would also be facilitated, and manipulation will not result in enlargement of the wound. This invention enables an easy-to-use eye model that is leak-free during simulation and has a more structurally sound port that is tear-resistant.

All references cited herein are expressly incorporated by reference in their entirety. There are many different features of the present disclosure and it is contemplated that these features may be used together or separately. Unless mention was made above to the contrary, it should be noted that all of the accompanying drawings are not to scale. Thus, the disclosure should not be limited to any particular combination of features or to a particular application of the disclosure. Further, it should be understood that variations and modifications within scope of the disclosure might occur to those skilled in the art to which the disclosure pertains. Accordingly, all expedient modifications readily attainable by one versed in the art from the disclosure set forth herein that are within the scope of the present disclosure are to be included as further embodiments of the present disclosure.

List of Reference Numerals:

| | |
|---|---|
| 100 | eye model |
| 110 | cornea |
| 150, 150A-H, K, M, N | tool tunnel |
| 152, 152K | tunnel end |
| 154, 154A | tunnel sidewall slope |
| 156 | tunnel sidewall |
| 158 | surface/exterior of eye |
| 160 | inside/interior of eye |
| 162, 162A | sidewall narrow portion |
| 170 | tool/instrument |
| 172 | tool sleeve |
| 174 | tool tip |
| 176 | narrow portion leading edge |
| 178 | narrow portion radiused edge |
| 180 | curved tunnel entry profile |
| 182 | curved entry straight portion |

What is claimed is:

1. A device for simulating surgery upon a natural eyeball, comprising:
at least a portion of an eyeball corresponding to the natural eyeball simulated, including an eyeball layer through which a surgical instrument is to be passed during the simulated surgery; and
a tunnel formed through the eyeball layer, the tunnel defining a cross-sectional profile substantially along the plane of the surface through which the surgical instrument is to be passed, the tunnel forming a taper along a depth defined as extending from a surface facing an exterior of the eye to a surface facing an interior of the eye.

2. The device of claim 1, the cross section defining direction changes of only curved shapes; whereby the tunnel does not form stress risers of sharp directional changes along the cross-section which can split when the surgical instrument is passed through the tool and moved during the surgical simulation.

3. The device of claim 2, wherein the curved shapes define one or more of a circular, oval, elliptical, parabolic, and/or a complex curve, the tunnel not defining substantially non-curved directional changes along the cross-section.

4. The device of claim 3, wherein the complex curve shape defines a curvy direction change formed by multiple radii.

5. The device of claim 1, wherein the tunnel is formed in the cornea and the surgery simulated is phacoemulsification.

6. The device of claim 1, wherein the eyeball layer is formed of a resilient material.

7. The device of claim 6, wherein at least a portion of the cross-section of the tunnel is sized smaller than a cross-section of the tool coplanar with the cross-section of the tunnel where the tool passes through the tunnel, whereby the tool forms an interference fit with tunnel.

8. The device of claim 1, wherein the tunnel diameter narrows at a point along a depth of the tunnel between an outer surface of the eye and an inner surface of the eye.

9. The device of claim 8, wherein the taper narrows toward the interior of the eye.

10. The device of claim 8, wherein the taper narrows toward the exterior of the eye.

11. The device of claim 8, wherein the taper narrows at a point along the depth of the tunnel between the interior and exterior of the eye.

12. The device of claim 6, wherein the tunnel forms a taper along a depth defined as extending from a surface facing an exterior of the eye to a surface facing an interior of the eye; and
wherein at least a portion of the cross-section of the tunnel through the taper is sized smaller than a cross-section of the tool coplanar with the cross-section of the tunnel where the tool passes through the taper, whereby the tool forms an interference fit with taper.

13. The device of claim 1, wherein
the layer through which the tunnel is formed is of a resilient material,
the tunnel forms a taper along a depth defined as extending from a surface facing an exterior of the eye to a surface facing an interior of the eye, and
the taper narrows toward the interior of the eye; and
the taper is folded inwards towards the interior of the eye and forms a seal with a surgical instrument, when a surgical instrument is inserted through the tunnel.

14. The device of claim 13, wherein the surgical instrument includes a deformable tube for conducting fluids between the interior and the exterior of the eye.

15. The device of claim 14, wherein
the folded taper forms an interference fit with the deformable tube,
the taper compresses the deformable tube to block fluid flow through the tube,
whereby
a first fluid pressure level can be introduced into the deformable tube from an exterior of the eye at which the compression of the taper is overcome and fluid can flow into the eye,
a second fluid pressure level can develop within the eye at which the compression of the taper is overcome and fluid can flow out of the eye, and
the second fluid pressure level is greater than the first fluid pressure, the taper thereby forming a type of one-valve.

16. The device of claim 14, wherein the folded taper forms an interference fit with the deformable tube, preventing fluid flow past the interference fit at a predetermined fluid pressure.

17. A synthetic eye model for simulating phacoemulsification procedures, comprising:
a flexible cornea having a pre-made tunnel with a continuous and smooth cross-sectional profile, substantially free from sharp corners or stress points.

18. The synthetic eye model of claim 17, wherein the pre-made tunnel has a cross-sectional profile characterized by one or more curved or rounded geometries.

19. The synthetic eye model of claim 17, wherein the pre-made tunnel has a cross-sectional profile selected from the group consisting of circular, elliptical, parabolic, and spline-based shapes.

20. The synthetic eye model of claim 17, wherein the pre-made tunnel has a cross-sectional profile that has a larger diameter nearest an exterior of the eye and a smaller diameter nearest an interior of the eye, and which forms a taper between the larger diameter to the smaller diameter, whereby a tool tip is guided along the taper to engage the smaller diameter in an interference fit, to thereby reduce the potential for a leak of fluid from inside the eye to an exterior of the eye when a tool is inserted into the tunnel.
